(19) United States
(12) Patent Application Publication
(10) Pub. No.: US 2012/0205151 A1
(43) Pub. Date: Aug. 16, 2012

(54) ANTICORROSIVE, COATED ELECTRIC WIRE WITH TERMINAL, AND WIRING HARNESS

(75) Inventors: Masato Inoue, Yokkaichi-shi (JP); Hiroshi Sudou, Yokkaichi-shi (JP); Tetsuya Nakamura, Yokkaichi-shi (JP); Hideki Imamura, Yokkaichi-shi (JP); Yasuyuki Otsuka, Yokkaichi-shi (JP); Yoshiaki Yamano, Yokkaichi-shi (JP); Kouji Fukumoto, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/500,992

(22) PCT Filed: Nov. 10, 2010
(86) PCT No.: PCT/JP2010/070051

§ 371 Date: Apr. 9, 2012

(30) Foreign Application Priority Data
Nov. 24, 2009 (JP) 2009-266527

(51) Int. Cl. H02G 3/04; C09D 167/00; C09D 167/06; H01B 3/44; C09D 123/08

(52) U.S. Cl. 174/72 A; 174/110 SR; 524/570; 524/556; 524/599

(57) ABSTRACT

Provided are an anticorrosive that is not sticky when a connected portion between a wire conductor and a terminal is subjected to anticorrosive treatment using the anticorrosive and accordingly has excellent handleability, and can coat the connected portion in a convincing way to prevent corrosion from building up at the connected portion, a coated electric wire with a terminal using the anticorrosive, and a wiring harness using the anticorrosive. The anticorrosive contains an ethylene-alpha-olefin copolymer that has a melt flow rate of 200 g/10 min or more at 190 degrees C. at 21.18 N, which is measured in accordance with the JIS K6922-1, wherein the ratio of copolymerization of an alpha-olefin in the ethylene-alpha-olefin copolymer is 10% by mass or more. In a coated electric wire with a terminal, a connected portion between a wire conductor and a terminal is coated with the anticorrosive.

### TECHNICAL FIELD

The present invention relates to an anticorrosive, a coated electric wire with a terminal, and a wiring harness, and more specifically relates to an anticorrosive that is favorably used to prevent corrosion at a connected portion between a conductor of a coated electric wire with a terminal and a terminal, a coated electric wire with a terminal using the anticorrosive, and a wiring harness using the anticorrosive.

### BACKGROUND ART

Conventionally, a coated electric wire, which is prepared by coating a conductor made of an annealed wire such as tough pitch copper with an insulation, is in widespread use as an electric wire used for wiring in a car such as an automobile. A terminal is connected to the conductor at an end of the coated electric wire, where the conductor is exposed by stripping off the insulation. The terminal that is connected to the end of the coated electric wire is inserted and locked into a connector.

A plurality of the coated electric wires are bunched into a wiring harness. The coated electric wires in the form of wiring harness are used for wiring in a car such as an automobile.

Used for wiring in an engine room or an indoor environment that is subject to water, the wiring harness is susceptible to heat and water, so that rust is liable to format connected portions between the conductors and the terminals. For this reason, it is necessary to subject the connected portions to anticorrosive treatment in order to prevent corrosion from building up at the connected portions when the wiring harness is used in this environment.

These days, there are increasing tendencies to improve fuel efficiency by weight reduction of a car such as an automobile, and accordingly weight reduction of material for the electric wires is demanded. For this reason, using aluminum for the conductors is considered. In this case, because copper or a copper alloy that is generally used for the terminals is used in combination with aluminum, bimetallic corrosion builds up at the connected portions between the conductors and the terminals, so that rust is more liable to form at the connected portions compared with a connected portion between a same kind of metals. For this reason, when aluminum is used, it is more highly necessary to subject the connected portions between the conductors and the terminals to anticorrosive treatment.

In order to prevent corrosion from building up at the connected portion between the conductors and the terminals, PTL 1 discloses anticorrosive treatment to fill with grease the connectors into which the terminals connected to the conductors at the ends of the electric wires are inserted and locked.

### CITATION LIST

### Patent Literature

PTLI: JP05-159846A

### SUMMARY OF INVENTION

### Technical Problem

However, in the anticorrosive treatment disclosed in PTL 1, there arises a problem that because the grease is filled in the connectors, the connectors and the electric wires are made sticky, which decreases handleability. Due to this problem, a material for anticorrosive treatment that replaces the grease is required.

An object of the present invention is to provide an anticorrosive that is not sticky when a connected portion between a wire conductor and a terminal is subjected to anticorrosive treatment using the anticorrosive and accordingly has excellent handleability, and can coat the connected portion in a -convincing way to prevent corrosion from building up at the connected portion. Other objects are to provide a coated electric wire with a terminal using the anticorrosive, and to provide a wiring harness using the anticorrosive.

### Solution to Problem

In order to solve the problems described above, the anticorrosive of the present invention contains an ethylene-alpha-olefin copolymer that has a melt flow rate of 200 g/10 min or more at 190 degrees C. at 21.18 N, which is measured in accordance with the JIS K6922-1, wherein the ratio of copolymerization of an alpha-olefin in the ethylene-alpha-olefin copolymer is 10% by mass or more.

It is preferable the alpha-olefin defines one or a plurality of monomers selected from the group consisting of a vinylester, an alpha, beta-unsaturated carboxylic acid alkyl ester, and a carboxyl group containing monomer.

In another aspect of the present invention, a coated electric wire with a terminal includes a wire conductor and a terminal, wherein a connected portion between the wire conductor and the terminal is coated with the anticorrosive.

It is preferable that in the coated electric wire with the terminal, the wire conductor includes elemental wires made of aluminum or an aluminum alloy, and the terminal is made of copper or a copper alloy.

Yet, in another aspect of the present invention, a wiring harness includes the coated electric wire with the terminal.

### Advantageous Effects of Invention

Containing the specific ethylene-alpha-olefin copolymer, the anticorrosive of the present invention is not sticky when the connected portion between the wire conductor and the terminal is subjected to anticorrosive treatment using the anticorrosive and accordingly has excellent handleability, and can coat the connected portion in a convincing way to prevent corrosion from building up at the connected portion.

If the alpha-olefin defines the one or the plurality of monomers described above, the anticorrosive has excellent affinity for the wire conductor and the terminal by a polar functional group of the alpha-olefin. Thus, the anticorrosive has especially excellent anticorrosive capability.

In addition, corrosion hardly builds up at the connected portion between the wire conductor and the terminal in the coated electric wire with the terminal using the anticorrosive of the present invention and the wiring harness using the anticorrosive of the present invention because the anticorrosive coats the connected portion. Thus, the coated electric wire with the terminal and the wiring harness can be used favorably for wiring in an engine room or an indoor environment that is subject to water. In addition, if the dissimilar metals such as the wire conductor including the elemental wires made of aluminum or an aluminum alloy and the terminal made of copper or a copper alloy are connected to each other, the coated electric wire with the terminal and the wiring harness have excellent anticorrosive capability because the anticorrosive coats the connected portion between the wire conductor and the terminal.

### BRIEF DESCRIPTION OF DRAWINGS

FIG. 1 is a view schematically showing a coated electric wire with a terminal of a first preferred embodiment of the present invention.

FIG. 2 is a cross-sectional view showing the same along the line A-A of FIG. 1.

FIG. 3 is a view for illustrating a corrosion test.

### DESCRIPTION OF EMBODIMENTS

A detailed description of preferred embodiments of the present invention will now be provided with reference to the accompanying drawings.

An anticorrosive of a preferred embodiment of the present invention mainly contains an ethylene-alpha-olefin copolymer. It is preferable that the anticorrosive contains only the ethylene-alpha-olefin copolymer, or contains an additive and another polymer as appropriate within a range of not impairing its physical properties.

The anticorrosive has a melt flow rate of 200 g/10 min or more at 190 degrees C. at 21.18 N, which is measured in accordance with the JIS K6922-1. If the MFR of the ethylene-alpha-olefin copolymer is less than 200 g/10 min, the anticorrosive is low in fluidity and cannot sufficiently coat a portion subjected to anticorrosive treatment. Thus, the anticorrosive cannot achieve a sufficient anticorrosion effect. The MFR of the ethylene-alpha-olefin copolymer is preferably 500 g/10 min or more, and more preferably 1000 g/10 min or more.

The anticorrosive has a ratio of copolymerization of the alpha-olefin in the ethylene-alpha-olefin copolymer that is 10% by mass or more. If the ratio of copolymerization of the alpha-olefin is less than 10% by mass, the anticorrosive has insufficient affinity (an insufficient wetting characteristic) for a wire conductor and a terminal. Thus, the anticorrosive cannot achieve a sufficient anticorrosion effect. The ratio of copolymerization of the alpha-olefin is preferably 15% by mass or more, and more preferably 20% by mass or more considering that an excellent anticorrosion effect can be obtained.

Examples of the alpha-olefin in the ethylene-alpha-olefin copolymer includes a vinylester, an alpha, beta-unsaturated carboxylic acid alkyl ester, and a carboxyl group containing monomer. These alpha-olefins have excellent effects of improving affinity (a wetting characteristic) for the wire conductor and the terminal. It is preferable that the ethylene-alpha-olefin copolymer defines a copolymer that contains ethylene and a single kind of alpha-olefin. It is also preferable that the ethylene-alpha-olefin copolymer defines a copolymer containing ethylene and two or more different kinds of alpha-olefins.

Examples of the vinylester include a vinyl propionate, a vinyl acetate, a vinyl caproate, a vinyl caprilate, a vinyl laurate, a vinyl stearate and a vinyl trifluoroacetate.

Examples of the alpha, beta-unsaturated carboxylic acid alkyl ester include a methyl acrylate, a methyl methacrylate, an ethyl acrylate and an ethyl methacrylate.

Examples of the carboxyl group containing monomer include a maleic acid anhydride.

Examples of the favorable ethylene-alpha-olefin copolymer include an ethylene-vinyl acetate copolymer (EVA), an ethylene-ethyl acrylate copolymer (EEA), an ethylene-methyl acrylate copolymer (EMA), an ethylene-methyl methacrylate copolymer (EMMA), an ethylene-methyl acrylate-maleic acid anhydride copolymer (maleic acid anhydride EMA).

The additive described above is not limited specifically as long as it defines an additive that can be generally used for a material for resin molding. To be specific, examples of the additive include a ninorganic filler, an antioxidant, a metal deactivator (a copper inhibitor), an ultraviolet absorber, an ultraviolet-concealing agent, a flame-retardant auxiliary agent, a processing aid (e.g., a lubricant, wax), and carbon and other coloring pigments.

It is preferable that the anticorrosive contains another copolymer material in addition to the ethylene-alpha-olefin copolymer as appropriate.

It is preferable that the ethylene-alpha-olefin copolymer and the another copolymer material contained as appropriate are cross-linked as appropriate in order to increase heat resistance and mechanical strength. Examples of a method for the crosslinking include a thermal crosslinking method, a chemical crosslinking method, a silane crosslinking method, an electron irradiation crosslinking method, and an ultraviolet crosslinking method, which are not limited specifically. The present anticorrosive is preferably cross-linked after covering the portion subjected to the anticorrosive treatment using the anticorrosive.

The anticorrosive of the present invention can be favorably used to prevent corrosion from building up at a connected portion between a conductor of a coated electric wire and a terminal used for wiring in a car such as an automobile.

Next, a description of a coated electric wire with a terminal of the present invention is provided.

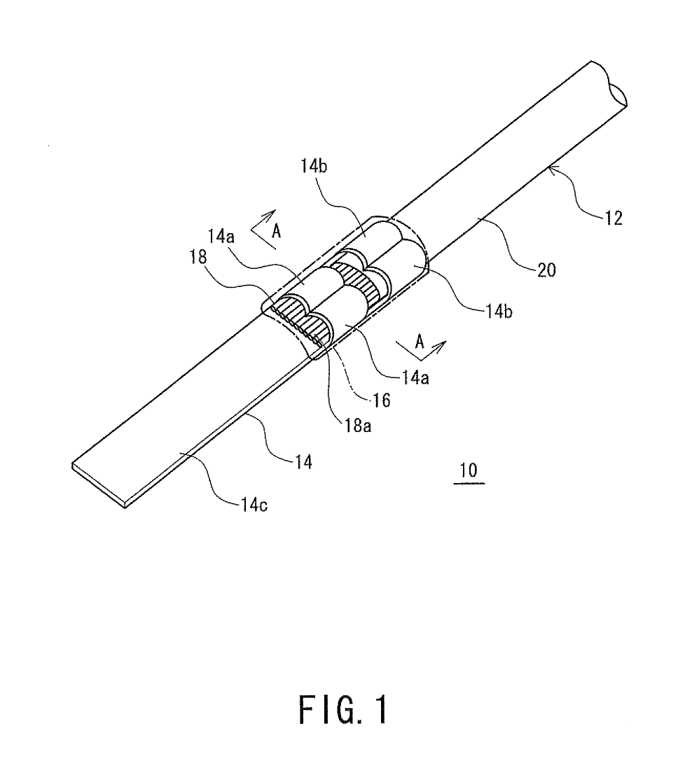

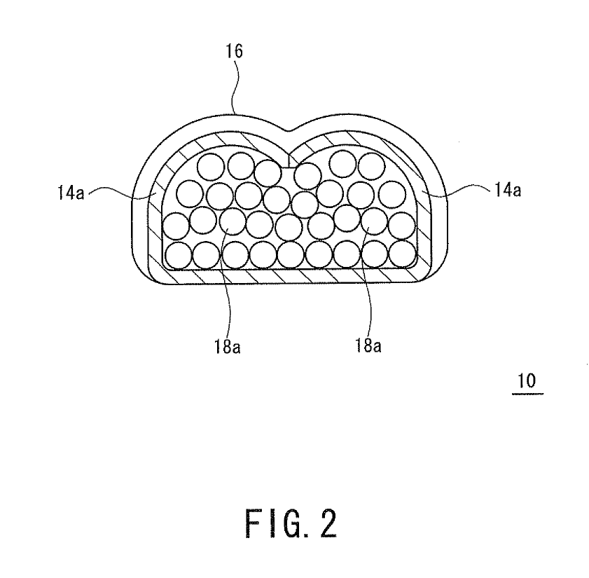

A coated electric wire 10 with a terminal includes a coated electric wire 12 including a wire conductor 18 and an insulation 20 with which the wire conductor 18 is coated, and a terminal 14 connected to an end of the wire conductor 18 of the coated electric wire 12, as shown in FIGS. 1 and 2.

The insulation 20 is peeled off at the end of the wire conductor 18 of the coated electric wire 12, so that the wire conductor 18 is exposed at the end. The terminal 14 is connected to the exposed end of the wire conductor 18. The wire conductor 18 defines a strand made up of a plurality of elemental wires 18a. In this case, the strand may be made up of metallic elemental wires of one kind, or may be made up of metallic elemental wires of two or more than two kinds. The strand may include an elemental wire made of an organic fiber in addition to the metallic elemental wires. It is to be noted that the metallic elemental wires of one kind define that all the metallic elemental wires of the strand are made of a same metallic material, and the metallic elemental wires of two or more than two kinds define that the metallic elemental wires made of different metallic materials are included in the strand. The strand may include also a reinforcement wire (tension member) for reinforcing the coated electric wire 12.

The metallic elemental wires are made preferably of copper, a copper alloy, aluminum, an aluminum alloy, or one of these materials that are plated with different kinds of materials. An elemental wire that is defined as the reinforcement wire is made preferably of a copper alloy, titanium, tungsten, or stainless steel. An elemental wire that is defined as the organic fiber is made preferably of aramid fiber such as KEVLAR (a registered trademark of DU PONT).

The insulation 20 is made preferably from rubber, polyolefin, PVC or a thermoplastic elastomer, which may be used singly or in combination. The insulation 20 may contain a variety of additives such as a flame retardant, a filler, and a coloring agent, as appropriate.

The terminal 14 includes a connecting portion 14c having the shape of a tub and arranged to be connected to a counterpart terminal, wire barrels 14a extending from a base end of the connecting portion 14c and crimped onto the end of the wire conductor 18 of the electric wire 12, and insulation barrels 14b extending from the wire barrels 14a and crimped onto the insulation 20 at the end of the coated electric wire 12.

The terminal 14 (a base member thereof) is made preferably of general brass, a variety of copper alloys and copper. It is preferable to plate a partial surface (e.g., a connecting point) or an entire surface of the terminal 14 with a variety of metals such as tin, nickel and gold.

A portion of the wire conductor 18 is exposed at a connected portion between the wire conductor 18 and the terminal 14. In the present coated electric wire 10 with the terminal, the exposed portion is coated with the anticorrosive described above. To be specific, a coating film 16 of the anticorrosive lies over from the base end of the connecting portion 14c while striding over the border between the base end of the connecting portion 14c of the terminal 14 and the end of the wire conductor 18 until the insulation 20 while striding over the border between the insulation barrels 14b of the terminal 14 and the insulation 20.

The anticorrosive is preferably selected as appropriate considering the combination of the material of the wire conductor 18 and the material of the terminal 14. The thickness of the coating film 16 of the anticorrosive is adjusted as appropriate; however, the thickness is preferably from 0.01 mm to 0.1 mm. If the thickness of the coating film 16 is too large, it is difficult for the terminal 14 to be inserted into a connector. On the other hand, if the thickness of the coating film 16 is too small, the anticorrosion effect is liable to lessened.

After crimping the terminal 14 onto the end of the coated electric wire 12 to connect the wire conductor 18 and the terminal 14, the anticorrosive is coated on a surface of the connected portion between the wire conductor 18 and the terminal 14, that is, a surface at the end of the insulation 20, surfaces of the insulation barrels 14b, surfaces of the wire barrels 14a, a surface of the exposed wire conductor 18, and a surface of the base end of the connecting portion 14c. Thus, the coating film 16 is formed on the surface of the connected portion between the wire conductor 18 and the terminal 14.

It is also preferable to form a coating film 16 on a back surface of the tub-shaped connecting portion 14c extending from the wire barrels 14a of the terminal 14, back surfaces of the wire barrels 14a, and back surfaces of the insulation barrels 14b if the formed coating film 16 does not impair the electrical connection.

In applying the anticorrosive, it is essential only that the anticorrosive should flow to the extent of being coatable. Thus, in applying the anticorrosive, it is preferable to heat it as appropriate, or to fluidity it using a solvent as appropriate. The application of the anticorrosive is performed preferably in a falling-drop method, a coating method, or an extrusion method.

It is preferable that the coating film 16 is cross-linked as appropriate in order to increase heat resistance and mechanical strength. Examples of a method for the crosslinking include a thermal crosslinking method, a chemical crosslinking method, a silane crosslinking method, an electron irradiation crosslinking method, and an ultraviolet crosslinking method, which are not limited specifically.

Mainly containing the specific ethylene-alpha-olefin copolymer, the anticorrosive demonstrates fluidity by heating. For this reason, the anticorrosive has an easy-to-apply property, which allows the anticorrosive to be applied to an intended site with precision in a convincing way. For example, even in a case where the coated electric wire 12 is small in diameter (e.g., 0.8 mm) and the terminal 14 is small in width (e.g., 0.64 mm at the tub), the anticorrosive can be applied only at the connected portion between the wire conductor 18 and the terminal 14 with precision in a convincing way.

In addition, being cooled and hardened after the application, the anticorrosive is not sticky at the time of handling, and can be fixed to the applied site over a long period of time. Thus, the anticorrosion effect can be sustained over a long period of time. Further, if the alpha-olefin has a polar functional group, the anticorrosive has excellent affinity for a metal material, and thus has an excellent wetting characteristic and an excellent adhesion property for the wire conductor 18 and the terminal 14. Thus, the anticorrosion effect can be sustained over a long period of time.

Next, a description of a wiring harness of the present invention is provided.

A plurality of coated electric wires with terminals including the present coated electric wire 10 with the terminal are bunched into the present wiring harness. In the present wiring harness, some of the included coated electric wires with the terminals may be the present coated electric wires 10 with the terminals, or all of the included coated electric wires with the terminals may be the present coated electric wires 10 with the terminals.

In the present wiring harness, the coated electric wires with the terminals may be bound with tape, or may be armored with an armoring member such as a circular tube, a corrugated tube and a protector.

The present wiring harness is favorably used for wiring in a car such as an automobile, especially for wiring in an engine room or the interior of a car that is subject to water. These sites are susceptible to heat and water, so that when a wiring harness is used for wiring in these sites, rust is liable to form at the connected portion between the wire conductor 18 and the terminal 14. However, using the present wiring harness can prevent rust from forming at the connected portion between the wire conductor 18 and the terminal 14.

### EXAMPLE

A description of the present invention will now be specifically provided with reference to Examples. It is to be noted that the present invention is not limited to Examples.

(Preparation of Coated Electric Wire)

A polyvinyl chloride composition was prepared as follows: 100 parts by mass of polyvinyl chloride (polymerization degree of 1300), 40 parts by mass of diisononyl phthalate that defines a plasticizer, 20 parts by mass of calcium carbonate heavy that defines a filler, and 5 parts by mass of a calcium-zinc stabilizer that defines a stabilizer were mixed at 180 degrees C. in an open roll, and the mixture was formed into pellets with the use of pelletizer. Then, a conductor (having a cross-sectional area of 0.75 mm) that defines an aluminum alloy strand that is made up of seven aluminum alloy wires was extrusion-coated with the polyvinyl chloride composition prepared as above such that the coat has a thickness of 0.28 mm. Thus, a coated electric wire (PVC electric wire) was prepared.

(Preparation of Coated Electric Wire with Terminal)

By using a plurality of the coated electric wires prepared as above, a coated electric wire with a terminal was prepared as follows. The coat was peeled off at an end of each coated electric wire to expose each wire conductor, and then a male crimping terminal (0.64 mm in width at a tub) made of brass generally used for automobile was crimped onto the ends of the coated electric wires. Then, one of ethylene-alpha-olefin copolymers of different kinds to be described later was applied to a connected portion between the wire conductors and the terminal, and thus the exposed wire conductors and barrels of the terminal were coated with the ethylene-alpha-olefin copolymer. In this manner, the plurality of coated electric wires with the terminals, of which the connected portions were coated with the ethylene-aipha-olefin copolymers of different kinds, were prepared. It is to be noted that the ethylene-alpha-olefin copolymers were heated to 230 degrees C. to fluidify, and applied such that the coats have a thickness of 0.05 mm.

(Ethylene-Alpha-Olefin Copolymer)
EVA (ethylene-vinyl acetate copolymer) [manuf.: DU PONT-MITSUI POLYCHEMICALS CO., LTD., trade name: “EVAFLEX EV205W” (14% by mass of comonomer, MFR 800)]
EEA (ethylene-ethyl acrylate copolymer) [manuf.: NIPPON UNICAR COMPANY LIMITED, trade name: “NUC-6090” (30% by mass of comonomer, MFR 1250)]
EMA <1> (ethylene-methyl acrylate copolymer) [manuf.: DU PONT-MITSUI POLYCHEMICALS CO., LTD., trade name: “NUCRELN2050H” (20% by mass of comonomer, MFR 500)]
EMMA (ethylene-methyl methacrylate copolymer) [manuf.: SUMITOMO CHEMICAL CO, LTD., trade name; “ACRYFT CM5021” (28% by mass of comonomer, MFR 450)]
Denatured EMA (ethylene-methyl acrylate-maleic acid anhydride copolymer) [manuf.: ARKEMA INC., trade name: “BONDINE HX8210” (10% by mass of comonomer, MFR 200)]
EMA <2< (ethylene-methyl acrylate copolymer) [manuf.: JAPAN POLYETHYLENE CORPORATION, trade name: “REXPEARL EMA EB440H” (20% by mass of comonomer, MFR 18)]
EAA (ethylene-acrylate copolymer) [manuf.: DU PONT-MITSUI POLYCHEMICALS CO., LTD., trade name: “NUCREL N1560” (15% by mass of comonomer, MFR 60)]
LDPE (low-density polyethylene) [manuf.: TOSOH CORPORATION, trade name: “PETROSEN 354” (0% by mass of comonomer, MFR 200)]

(Corrosion Test Procedure)

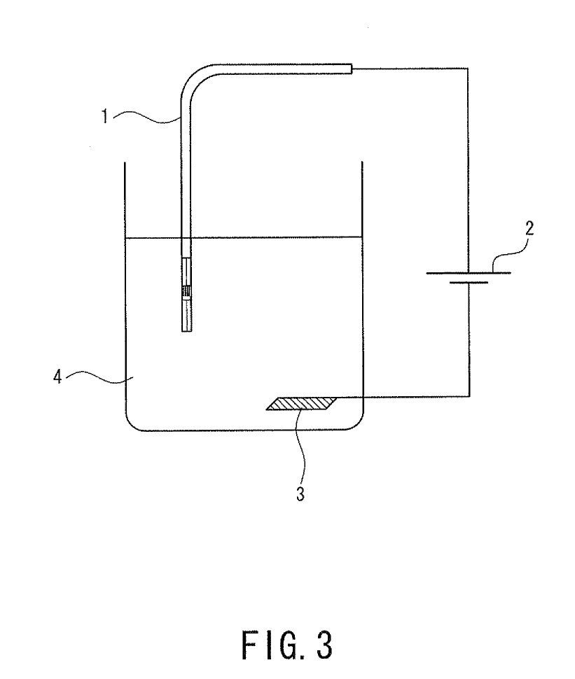

As shown in FIG. 3, each of the prepared coated electric wires 1 with the terminals was connected to a positive electrode of an electrical power source of 12 volts, while a pure copper plate 3 (1 cm×2 cm×1 mm) was connected to a negative electrode of the electrical power source of 12 volts. The pure copper plate 3 and each of the connected port ions between the wire conductors of the coated electric wires 1 and the terminals were immersed in 300 cc of a water solution 4 containing 5% of NaCl, and a voltage of 12 volts was applied thereto. After the application of the voltage, ICP emission analysis of the water solution 4 was performed to measure the amounts of aluminum, ions eluted from the wire conductors of the coated electric wires 1 with the terminals. The coated electric wires with the terminals in which the amounts of aluminum ions eluted from the wire conductors were less than 0.1 ppm were evaluated as PASSED. The coated electric wires with the terminals in which the amounts of aluminum ions eluted from the wire conductors were 0.1 ppm or more were evaluated as FAILED.

Table 1 shows the kinds of the anticorrosives, the MFRS and the ratios of copolymerization of the comonomers of Examples and Comparative Examples, and results of the corrosion tests. The MFRS define values that are measured at 190 degrees C. at 21.18 N in accordance with the JS K6922-1.

TABLE 1

| | Anticorrosive | | | |
|---|---|---|---|---|
| | | | Comonomer | |
| | | MFR | Amount | |
| | Kind | g/10 min. | % by mass | Evaluation |
| Example 1 | EVA | 800 | 14 | PASSED |
| Example 2 | EEA | 1250 | 30 | PASSED |
| Example 3 | EMA<1> | 500 | 20 | PASSED |
| Example 4 | EMMA | 450 | 28 | PASSED |
| Example 5 | Denatured EMA | 200 | 10 | PASSED |
| Comparative | EMA<2> | 18 | 20 | FAILED |
| Example 1 | | | | |
| Comparative | EAA | 60 | 15 | FAILED |
| Example 2 | | | | |
| Comparative | LDPE | 200 | 0 | FAILED |
| Example 3 | | | | |

The anticorrosives of Comparative Examples 1 and 2 contained the ethylene-alpha.-olefin copolymers that had relatively small MFRs, so that the anticorrosives were low in fluidity and could not sufficiently coat exposed wire conductors and barrels of terminals. Therefore, the anticorrosives of Comparative Examples 1 and 2 were inferior in anticorrosive capability. The anticorrosive of Comparative Example 3 contained the low-density polyethylene, so that the anticorrosive had an insufficient wetting characteristic and an insufficient adhesion property for a metallic surface. Therefore, the anticorrosive of Comparative Example 3 was inferior in anticorrosive capability.

Meanwhile, it is shown that the anticorrosives of present Examples were excellent in anticorrosive capability. In addition, it is shown that the anticorrosives of present Examples were not sticky because they contained the ethylene-alpha.-olefin copolymers.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

For example, though the coated electric wire 10 with the terminal has the configuration of including the male terminal including the tub-shaped connecting portion 14c, which defines the terminal 14, the present invention is not limited to this configuration. It is also preferable that a female terminal capable of fitting into a male terminal, or a tuning-fork terminal is used as the terminal 14. In addition, it is also preferable that the terminal 14 does not include the insulation barrels 14b, and the crimp is performed only by the wire barrels 14a. In addition, the method for connecting the wire conductor 12 and the terminal 14 is not limited to the crimp using the barrels, and it is also preferable that the wire conductor 12 and the terminal 14 are connected by a method such as pressure-resistance welding, ultrasonic welding and soldering. In addition, though the conductor 18 defines a strand in the preferred embodiments, it is preferable that the conductor 18 defines a single wire.

1. An anticorrosive that contains an ethylene-alpha-olefin copolymer that has a melt flow rate of 200 g/10 min or more at 190 degrees Cat 21.18 N, which is measured in accordance with the JIS K6922-1,
wherein the ratio of copolymerization of an alpha-olefin in the ethylene-alpha-olefin copolymer is 10% by mass or more.

2. The anticorrosive according to claim 1, wherein the alpha-olefin comprises one or a plurality of monomers selected from the group consisting of:
a vinylester;
an alpha, beta-unsaturated carboxylic acid alkyl ester; and
a carboxyl group containing monomer.

3. A coated electric wire with a terminal, the electric wire comprising a wire conductor and a terminal, wherein a connected portion between the wire conductor and the terminal is coated with the anticorrosive according to claim 2.

4. The coated electric wire with the terminal according to claim 3, wherein the wire conductor comprises elemental wires made of aluminum or an aluminum alloy, and the terminal is made of copper or a copper alloy.

5. A wiring harness comprising the coated electric wire with the terminal according to claim 4.

6. A wiring harness comprising the coated electric wire with the terminal according to claim 3.

7. A coated electric wire with a terminal, the electric wire comprising a wire conductor and a terminal, wherein a connected portion between the wire conductor and the terminal is coated with the anticorrosive according to claim 1.
